(19) United States
(12) Patent Application Publication
(10) Pub. No.: US 2014/0292635 A1
(43) Pub. Date: Oct. 2, 2014

(54) EXPECTED USER RESPONSE

(71) Applicant: NOKIA CORPORATION, Espoo (FI)

(72) Inventors: Akos Vetek, Helsinki (FI); Leo Karkkainen, Helsinki (FI); Vuokko Lantz, Vantaa (FI); Asta Karkkainen, Helsinki (FI)

(73) Assignee: Nokia Corporation, Espoo (FI)

(21) Appl. No.: 13/850,828

(22) Filed: Mar. 26, 2013

(51) Int. Cl. G06F 3/01

(52) U.S. Cl. CPC G06F 3/016
USPC 345/156

(57) ABSTRACT

An apparatus comprising at least one processor; and at least one memory including computer program code, the at least one memory and the computer program code configured to, with the at least one processor, cause the apparatus to perform at least the following: detect an indication that a user is available for interaction, responsive to detecting the indication, provide a haptic output pattern associated with an expected user response, detect a user input, wherein the user input is responsive to the haptic output pattern, compare the expected user response and the user input, and based on the said comparison, perform an action.

### TECHNICAL FIELD

The present application relates to haptic output and user interaction with a device.

### BACKGROUND

Electronic devices, such as home computers, mobile telephones, wearable devices and tablet computers, may be used for many purposes via different user applications. For example, a user of a mobile telephone may use an in-built camera of the mobile telephone to take photos or videos using a camera application of the mobile telephone. The user may also send and receive different types of messages (such as SMS, MMS and e-mail) using the messaging application(s) of the mobile telephone. Even further, the user may play games and view and update social networking profiles using the mobile telephone.

To be able to utilize the device in such ways, interaction with the device is needed. The interaction enables the user to access the functions and/or applications in the device the user wishes to utilize. Interaction is also needed to authenticate in case access to the device and/or to its functions and/or applications it to be restricted. In the interaction haptic output may be utilized.

### SUMMARY

According to a first example of an embodiment of the invention, there is an apparatus comprising at least one processor; and at least one memory including computer program code, the at least one memory and the computer program code configured to, with the at least one processor, cause the apparatus to perform at least the following:
detect an indication that a user is available for interaction,
responsive to detecting the indication, provide a haptic output pattern associated with a user response,
detect a user input, wherein the user input is responsive to the haptic output pattern,
compare the expected user response and the user input, and based on the said comparison,
perform an action.

According to a second example of an embodiments of the invention, there is a method comprising;
detecting an indication that a user is available for interaction,
responsive to detecting the indication, providing a haptic output pattern associated with a user response, detecting a user input, wherein the user input is responsive to the haptic output pattern,
comparing the expected user response and the user input, and
based on the said comparison, performing an action.

According to a third example of an embodiment, there is a computer program product comprising a computer-readable medium bearing computer program code embodied therein for use with a computer, the computer program code comprising;
code for detecting an indication that a user is available for interaction,
code for, responsive to detecting the indication, providing a haptic output pattern associated with a user response, detecting a user input, wherein the user input is responsive to the haptic output pattern,
code for comparing the expected user response and the user input, and
code for, based on the said comparison, performing an action.

According to a fourth example of the embodiment, there is an apparatus comprising;
means for detecting an indication that a user is available for interaction,
means for, responsive to detecting the indication, providing a haptic output pattern associated with a user response,
means for detecting a user input, wherein the user input is responsive to the haptic output pattern, means for comparing the expected user response and the user input, and
means for, based on the said comparison, performing an action.

### BRIEF DESCRIPTION OF THE DRAWINGS

Examples of embodiments of the invention will now be described with reference to the accompanying drawings which are by way of example only and in which:

FIG. 1 illustrates schematically apparatus according to a an example embodiment;

FIG. 2 illustrates schematically apparatus according to another example embodiment;

FIG. 3 is a flow chart of an example embodiment;

FIG. 4 is a flow chart of an example embodiment;

FIG. 5 is a flow chart of an example embodiment;

FIGS. 6A-6F illustrate an example embodiment;

FIGS. 7A-7C illustrate an example embodiment;

FIGS. 8A-8C illustrate an example embodiment; and

FIG. 9 illustrates an example embodiment.

### DESCRIPTION OF EXAMPLES OF EMBODIMENTS

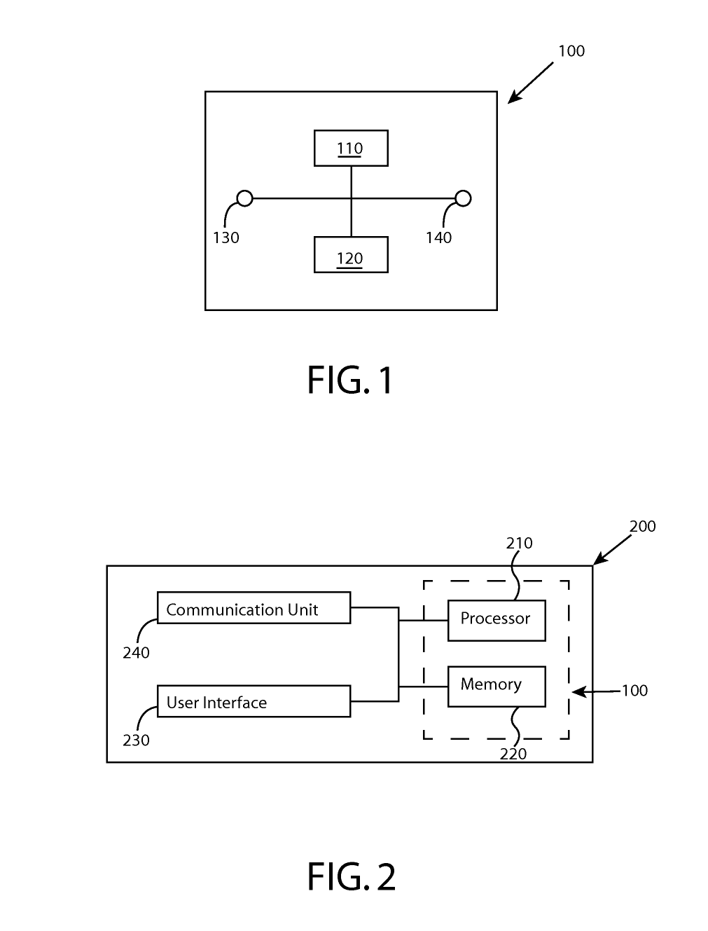

The examples of embodiments are described below with reference to FIGS. 1 through 9 of the drawings. Where appropriate, references to individual components which are described in the singular should be interpreted implicitly as also referring to a plurality of such components which are arranged to provide equivalent functionality.

Similarly where appropriate, references to a plurality of components (whether of the same or of different types) should be interpreted as implicitly also referring to a single component where such a single component is capable of providing equivalent functionality.

FIG. 1 of the accompanying drawings shows schematically an apparatus 100 according to an example of an embodiment of the invention. In FIG. 1, apparatus 100 comprises a plurality of components including at least one processor 110, at least one memory 120 including computer program code, and one or more suitable interfaces for receiving and transmitting data, shown here as input 130 and output 140 respectively.

An example of a processor 110 of a type suitable for use in the apparatus shown in FIG. 1 comprises a general purpose processor dedicated to execution and/or processing information.

An example of a memory 120 comprises a computer-readable medium for storing computer program code. Examples of computer-readable media include, for example, but are not limited to: a solid state memory, a hard drive, ROM, RAM or Flash. In some embodiments, the memory 120 of the apparatus shown in FIG. 1 comprises a plurality of memory units. Each memory unit may comprise the same type or be different types of memory unit to the other memory units. The computer program code stored in memory 120 comprises instructions for processing of information, such as, for example, data comprising information which is received via input 130. The instructions are executable by the processor 110.

In the embodiment shown in FIG. 1, memory 120 and processor 110 are connected by a coupling which allows the processor 110 to access the computer program code stored on the memory 120 and the processor 110 and memory 120 are also suitably electrically coupled to the input and output of the apparatus 100. In example embodiments where the apparatus 100 comprises an electrical integrated circuit, some or all of the components may be integrated with electrical connectivity to form the electrical integrated circuit. As mentioned above, it may also be possible for data to be transferred between some of the components 110, 120, 130, 140 using another type of coupling, for example, by an optical coupling.

As shown in FIG. 1, the input 130 provides data to the apparatus 100, for example, signalling from a component (no examples of such a component are shown in FIG. 1, see FIG. 2 for a schematic illustration of an example of an embodiment in which examples of such components are shown as user interface 230 and communications unit 240). Output 140 provides data from the apparatus 100, for example, signalling to another component such as the signalling generated by operations performed by the processor 110.

FIG. 2 shows an embodiment of device 200 according to an example of the invention which includes the components 110, 120, 130, 140 of the apparatus of FIG. 1. Various embodiments of device 200 are possible, for example in some embodiments, apparatus 100 is provided as a single chip, in other embodiments apparatus 100 is provided as a circuit, in other embodiments the components of apparatus 100 are located separately and dispersed with the other components of device 200. Examples of apparatus 100 provided as a single chip or circuit, include, for example, an Application Specific Integrated Circuit (also referred to as an “ASIC”), which may be provided either in an integrated form or as a module. It may also be possible to provide some components outside device 200, for example, some processing may be performed using a remote processor service, such as that offered by a “cloud” server, and similarly other functionality used by device 200 may be provided remotely.

As shown in the exemplary embodiment of FIG. 2, device 200 incorporates the functionality of apparatus 100 as a module, as is illustrated in FIG. 2 by the dashed line box. Examples of device 200 include mobile devices such as a mobile phone, the term mobile phone including a smart phone which is considered to be a high-end phone due to its high connectivity and information processing capabilities, PDA (Personal Digital Assistant), tablet computer, or the like. Device 200 is configured to provide suitable data for display (not shown in FIG. 2), which may be a display integrated with device 200 or a display which is connected to the device 200 by a suitable wireless or wired data connection.

FIG. 2 shows an exemplary embodiment of device 200 comprising a suitably configured memory 220 and processor 210, which receives data via a suitable input and output interfaces. As shown in FIG. 2, the input and output interfaces are implemented using a suitable user interface 230 which is configured to allow a user of the apparatus to interact with the device 200 and control the functionality provided by device 200.

The processor 210 is arranged to receive data from the memory 220, the user interface 230 or the communication unit 240. Data is output to a user of device 200 via the user interface 230 and/or is output via a suitable configured data interface to external devices which may be provided with, or be attachable to, the device 200.

Memory 220 comprises computer program code in the same way as the memory 120 of the apparatus 100. However, in some embodiments, memory 220 comprises other data. Memory 220 may comprise one or more memory units and have any suitable form or be of any suitable type appropriate for apparatus 200. For example, memory 220 may be provided as an internal built-in component of the device 200 or it may be an external, removable memory such as a USB memory stick, a memory card, network drive or CD/DVD ROM for example. The memory 220 is connected to the processor 210 and the processor may store data for later use to the memory 220.

The user interface 230 is configured to receive user input via a touch detection feature, and may also include one or more components for receiving user input, for example, a keypad, a microphone and/or one or more (other) physical buttons. The touch detection feature may be implemented in any suitable manner, for example, in some embodiments the touch detection feature comprises a proximity sensing feature that enables the device to detect hover gestures made by a user using his thumb, finger, palm, or other object, over a proximity-sensitive region of the device 200. The region for touch detection feature may be located at a certain part of the device 200 or it may extend such that hover gestures may be detected proximate to any part of the device 200. The touch detection feature may be provided by capacitive sensing technology, for example, or by any other means suitable. The user interface 230 may also include one or more components for providing output to a suitably configured display, and may provide other data for output to other components. The display may be for example a touch display, an LCD display, an eInk display or a 3D display. It is also possible that the display is a near-eye display, such as for example, glasses, worn by a user, which enable content to be displayed to user's vision. Other components may comprise components such as components for providing haptic feedback, a headset and loud speakers for example. It should be noted that the components for receiving user input and the components for providing output to the user may be components integrated to the device 200 or they may be components that are removable from the device 200. An example of a component that may be used for receiving user input and/or providing output to the user is a cover system, which can be connected to several different devices. An example of such a cover system is a container for a device 200 that may also be used with other devices.

Optionally, the device 200 may be provided with suitable wireless or wired data or voice connectivity, for example, it may be configured to use voice and/or data cellular communications network(s) and/or local area networks which may be wired or wireless (for example, an Ethernet network or a wireless local area network such as Wi-Fi, Wi-Max network and/or a short-range network such as a near field communications network or Blue-tooth network) either directly or via another device (ad-hoc networking).

As shown in the example of an embodiment of FIG. 2, communications connectivity is provided by a communication unit 240. The communication unit 240 may comprise for example a receiver, a transmitter and/or a transceiver. The communication unit 240 may be in contact with an antenna and thus enable connecting to a wireless network and/or a port for accepting a connection to a network such that data may be received or sent via one or more types of networks. The types of network may include for example a cellular network, a Wireless Local Area Network, Bluetooth or the like.

Devices may comprise information to which restricted accessibility is desirable. Restricted accessibility may be desired due to for example confidential nature of information available on the device. It may be that there are applications or functions on a device in which the information is not confidential and also applications or functions in which the information is confidential. In such a case it may be desirable to restrict access to the applications or functions that contain confidential information. To be able to restrict access, some form of identification is needed. In some cases, a password or pin number is used to authenticate a user. When using a password or a PIN, however, it is possible that another person is able to observe the password or PIN and thus gain access to confidential information. On the other hand, if authentication is done using means that require a user to look at the device when authenticating, it might be that the user is not able provide the authentication needed every time he wishes to gain access to the confidential information. For example, if the user is walking, running or driving his car, the user may have a head set and he may interact with the device using voice commands. In such a situation, it is not desirable to look at the device as the user needs to be aware of what is happening around him. On the other hand, the user most likely does not wish to use a voice command as an authentication as it would be easily observed by others. Thus it is desirable to have a method of authentication in which the user may have the authentication performed even if he does not look at the device and the authentication is performed in a way that is difficult to observe by others.

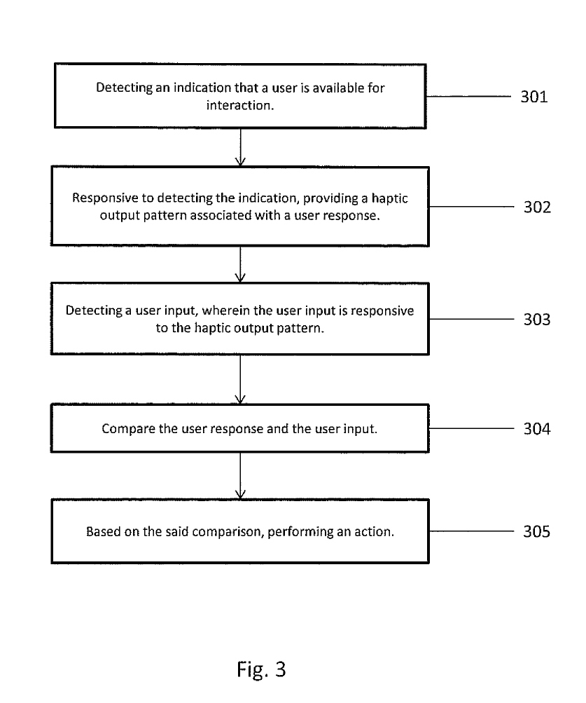

FIG. 3 is a flow chart illustrating an example embodiment. First, it is detected that a user is available for interaction 301. That is, a device receives an indication, which may be any suitable type of indication given by any suitable means, that may be interpreted to mean that the user is now ready to interact with the device. Examples of indications that may be used to indicate that the user is available for interaction include at least one or more of the following: detecting a grip, detecting a user digit(s) or a stylus, detecting a palm, receiving a voice command, detecting an indication when the device is in a certain position. It should be understood that any combination of the above mentioned examples of indications may also be used to indicate that the user is ready to interact with the device.

Next, responsive to detecting the indication, a haptic output pattern associated with an expected user response is provided 302. That is, responsive to detecting the indication, the device provides haptic feedback. The haptic feedback has a pattern, with which the user is familiar with. The pattern may be user-defined and/or the pattern may be derived from an audio file. The pattern is associated with a user response. The user response is a user input, or a sequence of user inputs, given by the user and detected by the device at certain time, or times, in relation to the haptic output pattern.

Next, a user input is detected, wherein the user input is responsive to the haptic output pattern 303. The user input is an input or a sequence of user inputs. The user inputs may be provided by any suitable means for providing a user input such as, for example, press of a button, touch user input, voice input or gaze-tracking based input.

After that, the user response and the user input are compared 304. In some example embodiments, the comparison comprises comparing the user response and user input detected. The comparison comprises comparing the time of the user input detected in relation to the haptic output pattern and that of the user response.

Based on the comparison, an action is performed 305. In some example embodiments, if the user input and the user response are equivalent or corresponding to each other within a reasonable margin, an action, such as for example unlocking a device, accessing restricted information or application, may be taken. If the user input and the user response are not equivalent or are not corresponding enough that they could be interpreted to be corresponding, another action, such as for example returning to the previous state or informing the user that the user input and the user response are not equivalent, may be taken. It should be noted that determining not to take an action may be considered as taking an action as well.

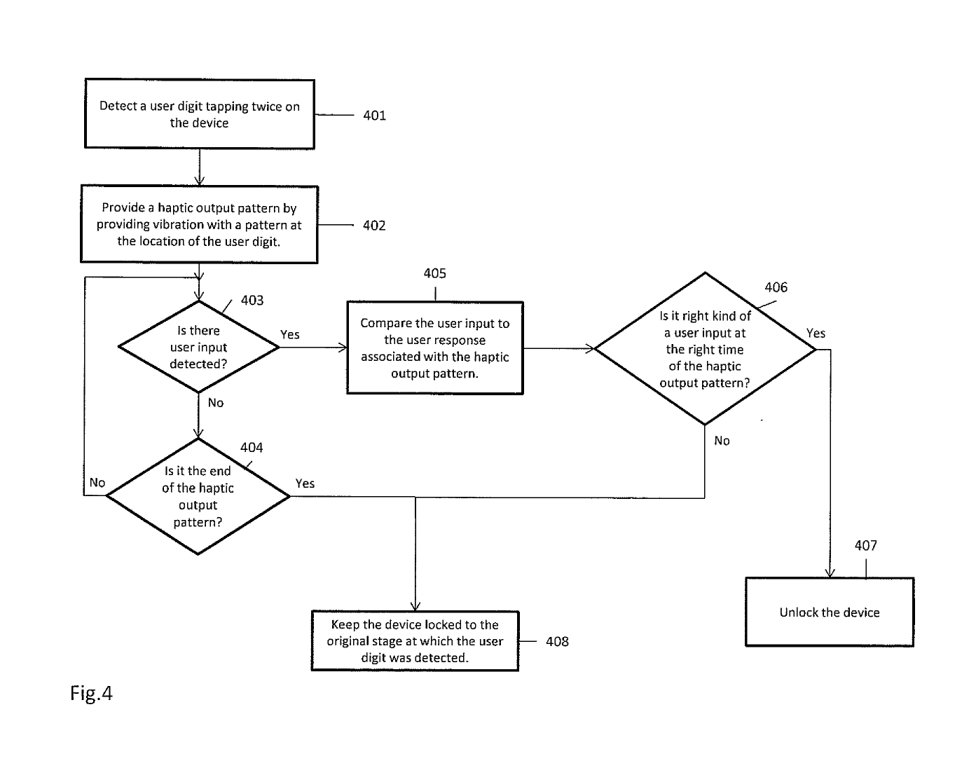

Turning now to FIG. 4, another flow chart illustrates another example embodiment. First, a user digit tapping on the device is detected 401. As this may be determined to be an indication that the user is available for interaction, a haptic output pattern is provided by providing vibration with a pattern at the location of the user digit 402. In some example embodiments, the location of the user digit may be determined by the user when tapping twice on the device. In some alternative example embodiments, the location of the user digits should be the location at which the haptic output pattern is provided.

Next, it is determined if there is user input detected 403. Should the determination be positive, the user input is compared to the user response associated with the haptic output pattern 405. Then it is determined if the user input is the right kind of user input provided at the right time of the haptic output pattern 406. In other words, does the user input correlate to the user response. Should the response be positive, then the device is unlocked 407. Should the response be negative, the device is kept locked to the original stage at which the user digit was detected 408.

Returning now to question 403, should the determination be negative, then question 404 follows. In question 404 it is determined if it is the end of the haptic output pattern. Should the determination be negative, then the question 403 follows again. However, should the determination be positive, then the device is kept locked to the original state at which the user digit was detected 408.

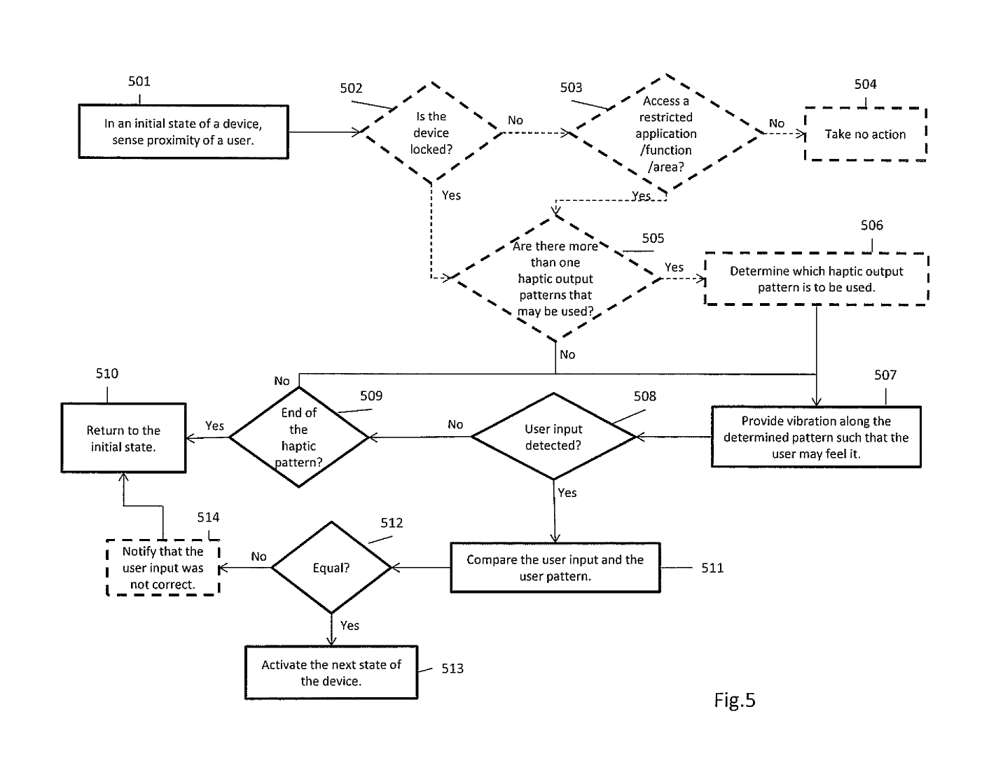

Turning now to FIG. 5, a further flow chart of another example embodiment is illustrated. Some parts in this flow chart are optional and are thus illustrated with dashed lines.

First, in an initial state of a device, proximity of a user is sensed 501. Next, it is determined if the device is locked 502. If the device is not, then it is determined if an access to a restricted application, function or an area can be made available 503. If the determination is negative, no action is taken 504. Had the determination in either the question 502 or 503 been positive, then it is determined if there are more than one haptic output patterns that may be used 505. Should the determination be positive, then it is determined which haptic output pattern is to be used 506. After the part 506, or if the determination in question 505 is negative, vibration along the determined haptic output pattern is provided such that the user may feel it 507. Next, it is determined if a user input is detected 508. If the determination is positive, then the user input and the user response are compared, 511. It is then determined if based on the comparison, it may be determined that the user input and the user response are equal or not 512. If they are equal, then the next state of the device is activated, follows 513.

If the comparison 512 determines that the user input and the user response are not equal, then the user is notified that the user input was not correct with respect to the user response 514. After that the device returns to the initial state 510.

Should the determination in question 508 be negative, it is determined if the end of the haptic pattern has been reached 509. If the determination is positive, then the device returns to the idle state 510. Should the determination be negative, then vibration along the determined haptic output pattern is provided such that the user may feel it 507.

Devices often contain private, sensitive and/or confidential information. In order to protect the information, authentication of a user is desirable. The authentication method may, however, be such that it may be observed by others is such a way that unwanted people may gain access to the information as well. In order to keep private, sensitive and/or confidential information safe, an authentication mechanism that is difficult or even impossible to observe is desirable. Such an authentication mechanism enables a discreet and unnoticeable. A way of achieving this utilizes haptic output provided by the device. Haptic output provides a user with feedback that the user may feel. Haptic output may include varying vibration strengths, frequency and patterns. Haptic output may be found for example in a touch panel, such as a capacitive panel for example, or a controller, such as a console game controller. Haptic output may be provided by actuators that provide mechanical motion in response to an electrical stimulus. Haptic output may be such that it vibrates the whole device or it may be applied locally, thus providing location specific haptic output. When actuators are utilized in providing haptic output, electromagnetic technologies are used where a central mass is moved by an applied magnetic field. The electromagnetic motors may operate at resonance and provide strong feedback, but produce a limited range of sensations. Actuators may also utilize technologies such as electroactive polymers, piezoelectric, electrostatic and subsonic audio wave surface actuation. Haptic output may also be provided without actuators by utilizing reverse-electrovibration. With reverse-electrovibration a weak current is sent from a device on the user through the object they the user is touching to the ground. The oscillating electric field around the skin on their fingertips creates a variable sensation of friction depending on the shape, frequency and amplitude of the signal.

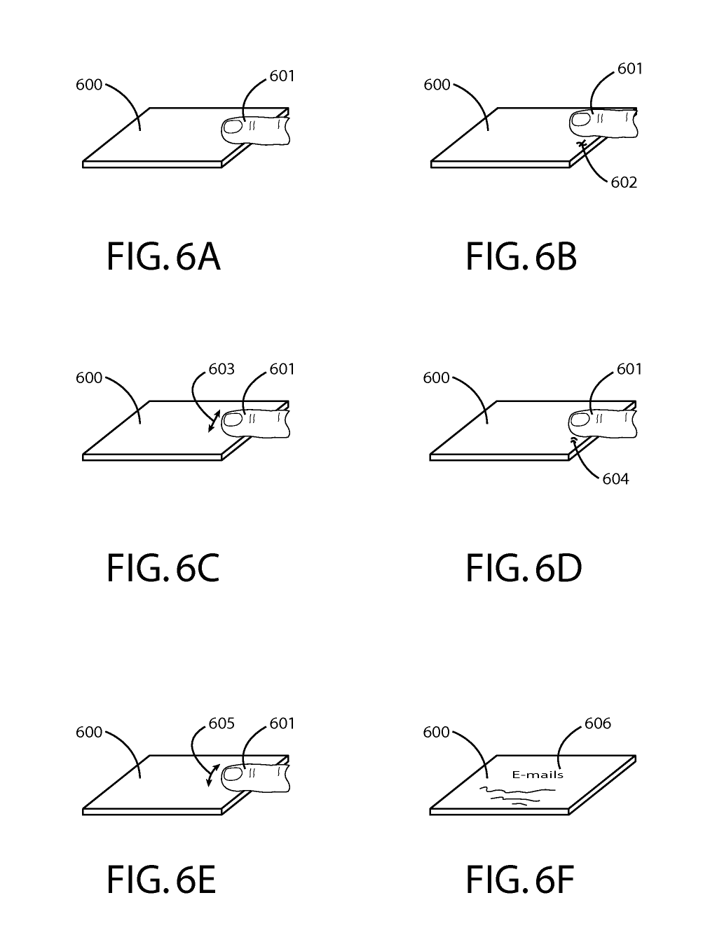

As haptic output may be felt by a user, it is possible for the user to place his palm or user digit on to a device and feel haptic output provided by the device. As the haptic output can be felt by the user when the palm or user digit is placed on the device, the haptic feedback is difficult to observe by another person thus enabling the haptic output to be personal and confidential. This feedback mechanism may be utilized for example when unlocking a device. For example, the user may place a finger on the device and in response the device produces haptic feedback which has a recognizable pattern. If the user then reacts to the haptic output pattern, by lifting the finger for example, at a predetermined phase of the pattern, the device may be unlocked. If the pre-determined pattern of the haptic output and the predetermined phases at which to react are known only to the user, then this unlocking mechanism can be secure and difficult to observe by others thus increasing the security of the device. Further examples of embodiments of the present invention are discussed below in reference to the FIGS. 6A to 8C.

FIGS. 6A to 6F schematically illustrate how haptic output may be utilized to authenticate if a user should have an access to an e-mail application. It may be that e-mail application in a device has tighter protection than some other applications in the same device. Thus when accessing the e-mail application, authentication may be required. FIGS. 6A to 6F schematically illustrate how this authentication may be achieved through the use of haptic output. The use case of an e-mail application is simply an example, however, the same approach may be used in authenticating the user for any other suitable purpose.

Turning now to FIG. 6A, there is a device 600. The device may be any device suitable for detecting a touch user input, providing access to an e-mail application and providing haptic output. In this example of an embodiment, the device 600 is a tablet device. To indicate that the user wishes to access the e-mail application, the user places finger 601 on the device and more precisely on an icon representing the e-mail application. In some alternative embodiments, other means for indicating that the user wishes to access the e-mail application may be used.

Upon detecting the input at the location of the icon, the device 600 produces a haptic output pattern 602 as illustrated in FIG. 6B. This haptic output pattern 602, in this example embodiment, is provided only at the location of the finger 601. In some alternative examples of an embodiment, the haptic output pattern may also be felt elsewhere than at the location of the finger 601. The haptic output pattern 602 is haptic output with a recognizable pattern. The haptic output pattern 602 is known to the user. The haptic output pattern 602 may be such that is saved in the device 600 and the user has then selected it. Alternatively, the haptic output pattern 602 may be such that is has been defined by the user. The user may define the haptic output pattern for example by selecting it among a set of predefined haptic output patterns or by selecting an audio file, the rhythm of which the haptic output pattern 602 is then to imitate.

Regarding the haptic output pattern 602, an association to a user response is present. The user response defines the type of user input that is to be given at a given stage of the haptic output pattern 602 by the user in order to access the secured data. In this example of an embodiment, as illustrated in FIG. 6C, the user knows what the pre-determined stage is and what the user input 603 that is to be given at that stage of the haptic output pattern 602 felt by the finger 601 is. In this example of an embodiment, the user input 603 is such that the finger 601 is lifted and then placed on the device 600 again. It is to be noted that any suitable user input, like, rocking a user digit, squeezing the device, press of button for example, may be used as the user input 603.

As in this example of an embodiment, the user response defines more than one pre-determined stages in the haptic output pattern 602 in which a certain user input is to be given. As the user input 603 has so far corresponded to the user response, the haptic output pattern continues 604 as is illustrated in FIG. 6D. It is to be noted that in some other example embodiments, the user response defines only one pre-determined stage.

In FIG. 6E, at the second pre-determined stage, the second user input 605 is given. The user input 605 may be any suitable user input. In this example embodiment, the user input 605 is a rocking gesture. Since the second user input also corresponds to the user response, access to the e-mail application is now provided as illustrated in FIG. 6F. Had either of the user inputs 603 and 605 not corresponded to the user response, the access to the e-mail application would have been prevented by the device 600.

In the example embodiment explained above with regard to FIGS. 6A to 6E the touch user input was detected and the haptic output was provided by the device 600. Alternatively, or in addition, a cover system could be used. The cover system (not shown in the Figures) is connectable to the device 600 and the activities included in the authentication can be divided in different ways between the cover system and the device. In an example embodiment, the division is such that the cover system detects the touch user input, provides the haptic output and detects if the user is authenticated or not. Should it be determined by the cover system that the access to the e-mail application is to be provided, the cover system then uses a secured connection between the cover system and the device 600 to pass on the information that access to the e-mail application may be granted to the device 600. Additionally, the cover system may be used not only with the device 600 but with other devices as well to authenticate the user.

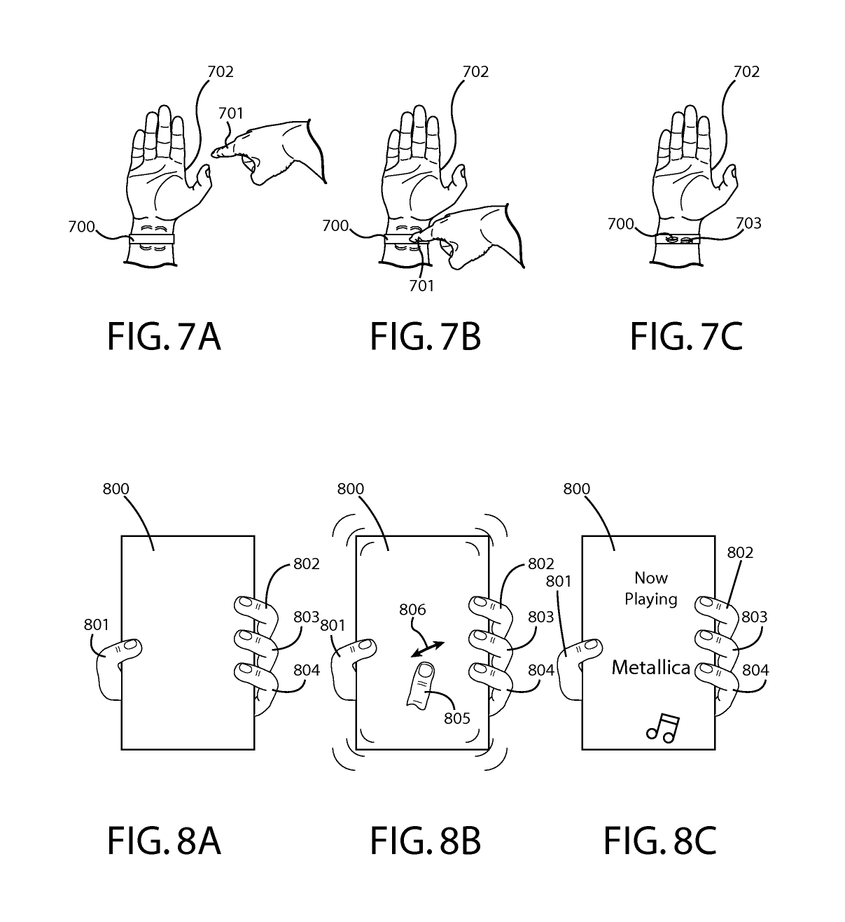

The present invention is also applicable to wearable devices such as a device worn on a wrist of a user or a device attached to some part of the user's body. A near-eye display that may remind glasses may also be such a device. In FIGS. 7A-7C an example of an embodiment is illustrated. In this example of an embodiment, there is a wearable device, which may be activated.

In FIG. 7A there is a wearable device 700. The device is worn on the wrist of the user 702 and the device 700 recognized a finger of the user 701. The device is in a mode in which its activities are minimal in order to save power consumption. In such a mode, the only activity performed by the device 700 may be displaying the time for example.

The device 700 may be capable of for example showing heart rate of the user, allow data to be sent to another device, receive data on the device 700 itself, and initiate communication and/or control playing of music. In order to access the activities of the device 700, the user may place his finger 701 on the device 700 as illustrated in FIG. 7B. Responsive to that, the device 700 produces haptic output pattern that has user response associated with it. In this example, the haptic output pattern is known to the user, so the user is able to provide corresponding user input at the correct stage of the haptic output pattern. That is, in this example of an embodiment, the user lifts his fingers at the correct stage of the haptic output pattern.

Responsive to the user input, the device 700 is activated as illustrated in FIG. 7C and thus the user has access to the activities enabled in the device 700.

Turning now to the example of an embodiment illustrated in FIGS. 8A-8C, there is a device that may be held on a hand of a user. The device is in a locked state, which means that in order to control the device, authentication of the user needs to be passed.

In FIG. 8A, there is a device 800. In this example of an embodiment the device is a mobile phone. Yet it should be noted that the device 800 may be any other suitable device as well, such as a tablet device or a PDA for example. The device 800 is held on the hand of the user, in other words, the device 800 is in the grip of the user. The FIG. 8A illustrates the grip by illustrating user digits 801-804. The device is now in the locked mode.

When the device is held in a grip and the user places a user digit 806 from the other hand to the device 800, the device receives an indication that the user is available for interaction. This is illustrated in FIG. 8B. In some alternative examples of an embodiment, the grip itself may be interpreted as an indication that the user is available for interaction. Once the device 800 receives the indication that the user is ready for interaction, it produces a haptic output pattern. The haptic output pattern is such that it may be felt throughout the device 800, not just at the location of the user digit 805. In other words the haptic output pattern is felt by the user digits 801-804 forming the grip as well. In some alternative examples of an embodiment, the haptic output pattern may be felt locally only at the location of the user digit placed on the device 800. At the pre-determined stage, or stages of the haptic output pattern, the user provides a user input 806. In this example of an embodiment, the user input 806 is a swipe gesture performed by the user digit 805. However, any detectable user input may also be used as the user input 806.

If the user input corresponds to the user response associated with the haptic output pattern, the device is unlocked to an active mode as is illustrated in FIG. 8C. In this example of an embodiment, the use is able to see what is being played at the moment. Had the user input 806 not corresponded to the user response associated with the haptic output, the device 800 would have remained in the locked state.

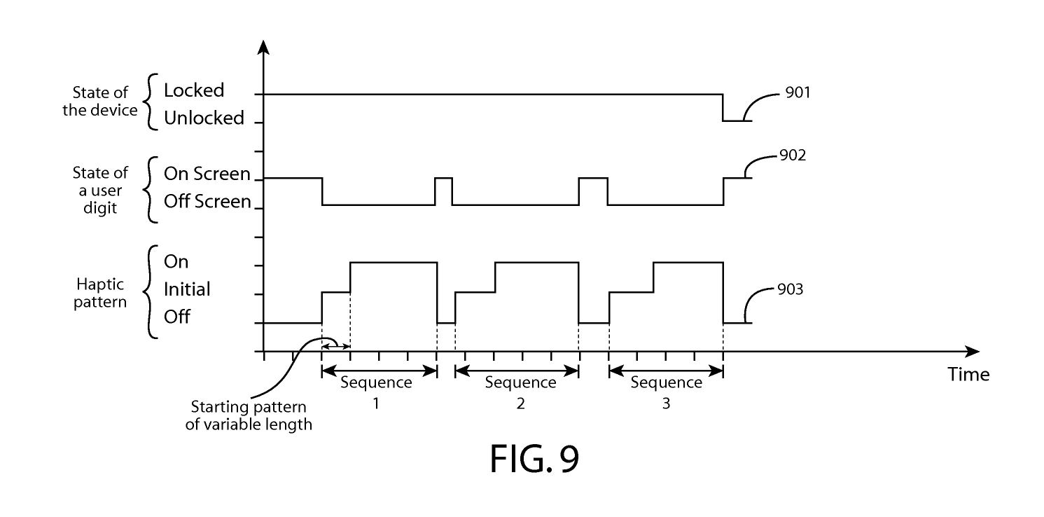

Turning now to FIG. 9, there is an illustration of the relation of the state of the device 901, the user input 902 and the haptic output pattern 903. In the FIG. 9, it may be seen that as the user places a user digit on to a screen of a device, that may be seen as an indication that the user is available for interaction and the haptic output pattern is initiated. As may be seen, the haptic output pattern 903 has 3 sequences after which the user is expected to lift the user digit off the screen and then put the user digit back on the screen. If the user digit is lifted after all the 3 sequences of the haptic output pattern 903, the state of the device changes from locked to unlocked.

Embodiments of the invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the invention as defined in the appended claims.

1-30. (canceled)

31. An apparatus comprising at least one processor; and at least one memory including computer program code, the at least one memory and the computer program code configured to, with the at least one processor, cause the apparatus to perform at least the following:
detect an indication that a user is available for interaction,
responsive to detecting the indication, provide a haptic output pattern associated with an expected user response,
detect a user input, wherein the user input is responsive to the haptic output pattern,
compare the expected user response and the user input, and
based on the said comparison, perform an action.

32. An apparatus according to claim 31, wherein detecting the indication comprises detecting the presence of the user.

33. An apparatus according to claim 32, wherein detecting the presence of the user comprises detecting a user digit.

34. An apparatus according to claim 31, wherein detecting the user input comprises detecting pressure applied to the device.

35. An apparatus according to claim 31, wherein detecting the user input comprises detecting a touch input or a hover input.

36. An apparatus according to claim 31, wherein the user input is a pattern of discrete input components.

37. An apparatus according to claim 31, wherein the expected user response comprises a type of user input and a user input timing relative to the haptic output pattern.

38. An apparatus according to claim 31, wherein the action to be taking is to change a state of a device provided that the expected user response and the detected user input match.

39. An apparatus according to claim 31, wherein the haptic output pattern is derived from an audio file.

40. An apparatus according to claim 31, wherein the haptic output pattern is user-defined using by at least one of the following: tapping a sequence on the device, motioning the device in a sequence, and swiping a finger in a sequence on the device.

41. A method comprising:
detecting an indication that a user is available for interaction,
responsive to detecting the indication, providing a haptic output pattern associated with an expected user response,
detecting a user input, wherein the user input is responsive to the haptic output pattern,
comparing the expected user response and the user input, and
based on the said comparison, performing an action.

42. A method according to claim 41, wherein detecting the user input comprises detecting a touch input or a hover input.

43. A method according to claim 41, wherein the user input is a pattern of discrete input components.

44. A method according to claim 41, wherein the expected user response comprises a type of user input and a user input timing relative to the haptic output pattern.

45. A method according to claim 41, wherein the action to be taking is to change a state of a device provided that the expected user response and the detected user input match.

46. A computer program product comprising a computer-readable medium bearing computer program code embodied therein for use with a computer, the computer program code comprising:
code for detecting an indication that a user is available for interaction,
code for, responsive to detecting the indication, providing a haptic output pattern associated with an expected user response,
code for detecting a user input, wherein the user input is responsive to the haptic output pattern,
code for comparing the expected user response and the user input, and
based on the said comparison, performing an action.

47. A computer program product to claim 46, wherein detecting the user input comprises detecting a touch input or a hover input.

48. A computer program product according to claim 46, wherein the user input is a pattern of discrete input components

49. A computer program product according to claim 46, wherein the expected user response comprises a type of user input and a user input timing relative to the haptic output pattern.

50. A computer program product according to claim 46, wherein the action to be taking is to change a state of a device provided that the expected user response and the detected user input are match.
